(19) United States
(12) Patent Application Publication
(10) Pub. No.: US 2015/0294547 A1
(43) Pub. Date: Oct. 15, 2015

(54) DRIVER CONDITION DETECTION APPARATUS, DRIVING ASSISTANCE APPARATUS, DRIVER CONDITION DETECTION METHOD, AND DRIVING ASSISTANCE METHOD

(71) Applicant: DENSO CORPORATION, Kariya-city (JP)

(72) Inventors: Yukari ITO, Kariya-city (JP); Takahiro NAITO, Nukata-gun (JP); Takuya KUME, Kasugai-city (JP)

(21) Appl. No.: 14/672,736

(22) Filed: Mar. 30, 2015

(30) Foreign Application Priority Data
Apr. 15, 2014 (JP) 2014-83244
May 7, 2014 (JP) 2014-96174

(51) Int. Cl. G08B 21/02; B60R 25/00

(52) U.S. Cl. CPC G08B 21/02; B60R 25/00

(57) ABSTRACT

A driver condition detection apparatus, which detects a condition of a driver during a driving of a vehicle, includes a position detection unit detecting a present position of the vehicle, a position determination unit determining whether the present position of the vehicle is equal to a detection target position that is preliminarily set, a driving behavior detection unit detecting a driving behavior of the driver or a driving behavior of the vehicle when the present position of the vehicle is equal to the detection target position, and a condition detection unit detecting a condition of the driver based on the driving behavior.

### CROSS REFERENCE TO RELATED APPLICATION

This application is based on Japanese Patent Application No. 2014-083244 filed on Apr. 15, 2014 and Japanese Patent Application No. 2014-096174 filed on May 7, 2014, the disclosures of which are incorporated herein by references.

### TECHNICAL FIELD

The present disclosure relates to a driver condition detection apparatus, a driving assistance apparatus, and a driver condition detection method for detecting a condition of a driver of a vehicle during a driving, and further relates to a driving assistance apparatus and a driving assistance method for assisting a driving of a vehicle corresponding to a condition of a driver.

### BACKGROUND

Various kinds of technologies are provided for detecting a condition of a driver during a driving of a vehicle in order to carry out a driving assistance corresponding to the condition of the driver. For example, a technology is proposed for detecting an abnormal condition of a driver by comparing subject biological information of the driver, which is detected during the driving, with reference biological information, which was detected in the past when the driver is in a normal condition. Herein, the biological information may be one of a heart rate, a pulse, or a blood pressure.

Further, a detection accuracy of the biological information may be affected by a surrounding traffic environment. For example, the surrounding traffic environment may include a congestion level of the traffic, a width of a road travelled by the subject vehicle, or the like. In order to suppress the effect of the surrounding traffic environment to the detected biological information, as disclosed in JP 3963072 B2, the biological information of the driver is detected only when the surrounding traffic environment is determined to be proper for detecting the biological information of the driver.

Further, a technology has been developed for particularly detecting a drowsiness or absent-minded state of the driver as the abnormal condition of the driver. In this kind of technology, in order to detect the drowsiness or the absent-minded state of the driver, images of the driver's face are taken during the driving of the vehicle by an image taking device, and the images are analyzed for determining the drowsiness or the absent-minded state of the driver.

In the above-described technology, the driver is required to wear various sensors for detecting the heart rate, the pulse, or the blood pressure. Thus, the driver may feel burdened to wear the various sensors.

When detecting the drowsiness or the absent-minded state of the driver as the condition of the driver, wearing of the various sensors is not required to the driver. Instead, a camera for taking images of the driver's face, a device for analyzing the face images of the driver need to be disposed in the vehicle and a configuration of the vehicle and a control to the vehicular devices may become complicated.

Further, as disclosed in JP 2009-21367 A, a condition of a driver is determined based on biological information of the driver. The biological information includes a heart rate, a blood pressure or the like. When the driver is not in a good condition, a driving assistance is carried out by assisting a driving behavior of the driver according to the condition of the driver in order to secure a driving safety. The driving behavior may include a pedal operation. Herein, the condition of the driver indicates a health condition or a physical condition of the driver.

Usually, a driving time of a person during one day is relatively short. Thus, when a condition of the driver is detected and determined only during the driving time, the determination result may have a low accuracy. In order to suppress an adverse effect caused by the assistance made to the driving behavior of the driver based on the determination result having a low accuracy, JP 2012-091570 A discloses a technology described below. According to JP 2012-091570 A, an accuracy of the determination result of the driver's condition is improved with consideration of the biological information detected during the driving time together with the biological information detected during a non-driving time. The biological information during the non-driving time may be detected by a mobile terminal carried by the person.

According to above-described technologies, even when the driver has no self-awareness to the abnormal condition of himself or herself, the driving assistance is carried out to assist the driving behavior of the driver in response to a detection of the abnormal condition of the driver. Thus, the driver may wrongly take the driving assistance, which is automatically carried out, as an abnormal driving behavior of the vehicle.

### SUMMARY

In view of the foregoing difficulties, it is an object of the present disclosure to provide a driver condition detection apparatus, a driver condition detecting method, and a driving assistance apparatus, each of which is able to detect an abnormal condition of the driver without requiring the driver to wear various sensors and is able to suppress a complication of a vehicle configuration and a complication of a control to the vehicular devices.

It is another object of the present disclosure to provide a driving assistance apparatus and a driving assistance method, each of which is able to secure a driving safety in response to a detection of an abnormal condition of the driver without providing a misleading information to the driver even when the driver has no self-awareness to the abnormal condition of himself or herself.

According to a first aspect of the present disclosure, a driver condition detection apparatus, which detects a condition of a driver during a driving of a vehicle, includes a position detection unit detecting a present position of the vehicle, a position determination unit determining whether the present position of the vehicle is equal to a detection target position that is preliminarily set, a driving behavior detection unit detecting a driving behavior of the driver or a driving behavior of the vehicle when the present position of the vehicle is equal to the detection target position, and a condition detection unit detecting a condition of the driver based on the driving behavior.

With the above apparatus, an abnormal condition of the driver can be detected without requiring the driver to wear various sensors, and a complication of a vehicle configuration and a complication of a control to the vehicular devices can be suppressed.

According to a second aspect of the present disclosure, a driving assistance apparatus includes the driver condition detection apparatus according to the first aspect and a driving assistance unit, which performs a driving assistance based on the condition of the driver detected by the condition detection unit.

With the above apparatus, advantages similar to the advantages provided by the driver condition detection apparatus according to the first aspect are provided.

According to a third aspect of the present disclosure, a driver condition detection method for detecting a present position of the vehicle, determining whether the present position of the vehicle is equal to a detection target position that is preliminarily set, detecting a driving behavior of the driver or a driving behavior of the vehicle when the present position of the vehicle is equal to the detection target position, and detecting a condition of the driver based on the driving behavior that is detected.

With the above method, an abnormal condition of the driver can be detected without requiring the driver to wear various sensors, and a complication of a vehicle configuration and a complication of a control to the vehicular devices can be suppressed.

According to a fourth aspect of the present disclosure, a driving assistance apparatus, which performs a driving assistance operation that is at least one of an operation that assists a driving of the vehicle by a driver or an operation that notifies information necessary for the driving of the vehicle, includes a parameter storing unit storing a plurality of operation parameters to be used for the driving assistance operation, a biological information detection unit detecting a biological information of the driver, a driving behavior detection unit detecting a driving behavior of the driver, a condition determination unit determining a condition of the driver based on at least one of the biological information of the driver or the driving behavior of the driver, a parameter selection unit selecting the operation parameters based on the condition of the driver determined by the condition determination unit and acquiring the operation parameters that are selected from the parameter storing unit, and a driving assistance unit performing the driving assistance operation based on the operation parameters selected by the parameter selection unit.

With the above apparatus, a driving assistance is carried out in response to a detection of an abnormal condition of the driver without providing misleading information to the driver even when the driver has no self-awareness to the abnormal condition of himself or herself.

According to a fifth aspect of the present disclosure, a driving assistance method for performing a driving assistance operation is provided. The driving assistance operation is at least one of an operation that assists a driving of the vehicle by a driver or an operation that notifies information necessary for the driving of the vehicle. The driving assistance method includes detecting at least one of a biological information of the driver or a driving behavior of the driver, determining a condition of the driver based on the at least one of the biological information of the driver or the driving behavior of the driver, selecting operation parameters to be used in the driving assistance operation based on the condition of the driver, and performing the driving assistance operation based on the operation parameters that are selected.

With the above method, a driving assistance is carried out in response to a detection of an abnormal condition of the driver without providing misleading information to the driver even when the driver has no self-awareness to the abnormal condition of himself or herself.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a configuration of a vehicular control apparatus including a driving assistance apparatus according to a first embodiment of the present disclosure;

FIG. 2 is a flowchart showing a driving assistance process executed by the driving assistance apparatus according to the first embodiment of the present disclosure;

FIG. 3 is a diagram showing operation parameter sets that are referred by the driving assistance process according to the first embodiment of the present disclosure;

FIG. 4 is a flowchart showing a driving assistance process executed by a driving assistance apparatus according to a second embodiment of the present disclosure;

FIG. 5 is a diagram showing an example of adjustment coefficients for adjusting respective operation parameters corresponding to a condition of the driver;

FIG. 6 is a block diagram showing a configuration of a driving assistance apparatus including a driver condition detection apparatus according to a third embodiment of the present disclosure;

FIG. 7A is a diagram showing a detection result of multiple vehicle speeds detected at respective positions over time when a brake is actuated, and FIG. 7B is a diagram showing a detection result of multiple depressing amounts of a brake pedal detected at respective positions over time when the brake is actuated;

FIG. 8A is a diagram showing a detection result of vehicle speeds at a position over time when a brake is actuated, and FIG. 8B is a diagram showing a detection result of depressing amounts of a brake pedal at a position over time when the brake is actuated;

FIG. 9A is a diagram showing a relation between a condition of a driver and a vehicle speed at a position when a brake is actuated, and FIG. 9B is a diagram showing a relation between a condition of a driver and a depressing amount of a brake pedal at a position over time when the brake is actuated;

FIG. 10A is a diagram showing a relation between a condition of a driver and a vehicle speed at a position when an accelerator is actuated, and FIG. 10B is a diagram showing a relation between a condition of a driver and a depressing amount of an accelerator pedal at a position when an accelerator is actuated;

FIG. 11 is a flowchart showing a driving assistance process executed by the driving assistance apparatus according to the third embodiment of the present disclosure;

FIG. 12 is a block diagram showing a configuration of a driving assistance apparatus including a driver condition detection apparatus according to a fourth embodiment of the present disclosure; and

FIG. 13 is a block diagram showing a configuration of a driving assistance apparatus including a driver condition detection apparatus according to a fifth embodiment of the present disclosure.

### DETAILED DESCRIPTION

The following will describe embodiments of the present disclosure with reference to the accompanying drawings.

### First Embodiment

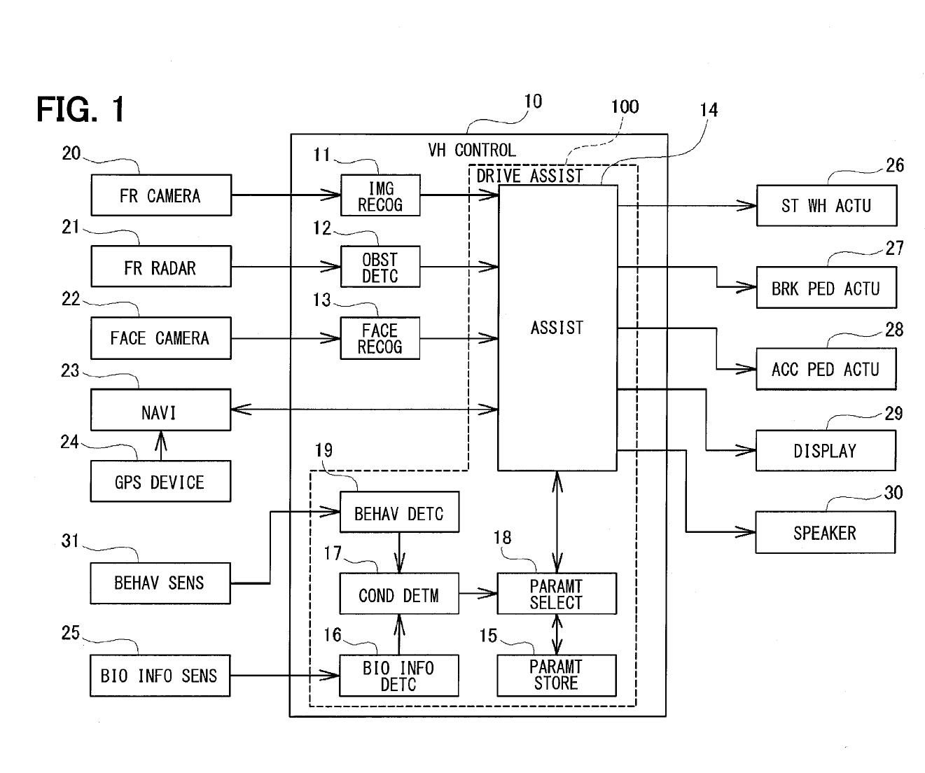

As shown in FIG. 1, a vehicular control apparatus (VH CONTROL) 10 includes a driving assistance apparatus (DRIVE ASSIST) 100, an image recognition unit (IMG RECOG) 11, an obstacle detection unit (OBST DETC) 12, and a face image recognition unit (FACE RECOG) 13. The driving assistance apparatus 100 includes a driving assistance unit (ASSIST) 14, a parameter storing unit (PARAMT STORE) 15, a biological information detection unit (BIO INFO DETC) 16, a condition determination unit (COND DETM) 17, a parameter selection unit (PARAMT SELECT) 18, and a driving behavior detection unit (BEHAV DETC) 19.

Each of the above-described units is a functional unit of the vehicular control apparatus 10, and does not indicate that the vehicular control apparatus 10 is physically divided into above-described nine units.

Each or any combination of units described above can be achieved as (i) a software section implemented by execution of a program by a central processing unit, (ii) a software section in combination with a hardware unit (e.g., computer) or (iii) a hardware section, including or not including a function of a related apparatus; furthermore, the hardware section (e.g., an electric circuit including a large-scale integrated circuit and a memory, a hard-wired logic circuit) may be constructed inside of a microcomputer.

In the present embodiment, the vehicular control apparatus 10 is provided by a microcomputer including a central processing unit, a real-only memory, and a random access memory. A program executed by the central processing unit provides a function of each unit included in the vehicular control apparatus 10.

The image recognition unit 11 acquires images taken by a front camera (FR CAMERA) 20 (not shown) in a front direction of a vehicle. The front camera 20 is equipped to the vehicle and takes images in the front direction of the vehicle. The front direction of the vehicle is also known as a travelling direction of the vehicle. The image recognition unit 11 recognizes positions of marked lines on a road surface, a front vehicle travelling in front of the vehicle, and an obstacle existing ahead of the subject vehicle. Then, the image recognition unit 11 outputs the recognition results to the driving assistance unit 14. The marked lines on the road surface usually indicate traffic lanes or the center line.

The obstacle detection unit 12 detects an obstacle existing ahead of the subject vehicle in a travel direction using a front radar (FR RADAR) 21 equipped to a front grille (not shown) of the vehicle. The obstacle existing ahead of the vehicle includes a front vehicle travelling in front of the subject vehicle. The obstacle detection unit 12 further detects a distance from the subject vehicle to the obstacle, and outputs the distance to the driving assistance unit 14.

The face image recognition unit 13 acquires and analyzes images of the driver's face. The images of the driver's face are taken by a driver face camera (FACE CAMERA) 22. The face image recognition unit 13 further extracts feature values of locations of eyes, locations of pupils, locations of eyelids, a location of nose, a location of a mouth, or the like by analyzing the images taken by the driver face camera 22. Then, the face image recognition unit 13 detects an orientation of the face, a direction of a line of sight, an opening level of the eye, a frequency of blink, a speed of blink, or the like. Then, the face image recognition unit 13 outputs a recognition result of the face images to the driving assistance unit 14. The driver face camera 22 is equipped in a compartment of the vehicle. For example, the driver face camera 22 may be positioned farther than a steering wheel of the vehicle with respect to a driver seat and obliquely downward with respect to the steering wheel. The driver face camera 22 takes images of the driver's face using various lights having wavelengths within a near infrared region.

The driving assistance unit 14 is connected with a steering wheel actuator (ST WH ACTU) 26, a brake pedal actuator (BRK PED ACTU) 27, an accelerator pedal actuator (ACC PED ACTU) 28, a display device (DISPLAY) 29, and a speaker 30. The driving assistance unit 14 performs various kinds of driving assistances based on informations transmitted from the image recognition unit 11, from the obstacle detection unit 12, and from the face image recognition unit 13. For example, the driving assistance unit 14 performs a lane keeping assistance by controlling the vehicle to remain in the marked lanes based on the marked line information detected by the image recognition unit 11.

As another example, the driving assistance unit 14 performs a following travelling assistance by controlling the vehicle to travel following the front vehicle based on the distance information, which is detected by the image recognition unit 11 and the obstacle detection unit 12. The distance information indicates a distance from the subject vehicle to the front vehicle or a distance from the subject vehicle to an obstacle existing ahead of the subject vehicle.

As another example, the driving assistance unit 14 performs a collision avoiding assistance by controlling the vehicle to avoid a collision with an obstacle.

As another example, the driving assistance unit 14 performs an absent-minded state monitoring assistance by monitoring a condition of the driver. Specifically, the driving assistance unit 14 outputs a warning to the driver when determining the absent-minded state of the driver based on the feature values of the driver's face transmitted from the face image recognition unit 13 and driving behaviors carried out by the driver. When the driver still continues the driving after the warning of the absent-minded state, the driving assistance unit 14 repeatedly outputs warnings to the driver at a predetermined time interval.

As another example, the driving assistance unit 14 performs navigation assistance by communicating with a navigation system (NAVI) 23, which is connected with a global positioning satellite (GPS) device (GPS DEVICE) 24, and guides a route to a destination.

The parameter storing unit 15 stores operation parameters. The operation parameters are used in the above-described driving assistances carried out by the driving assistance unit 14. The operation parameters will be described later in detail.

The biological information detection unit 16 detects biological information of the driver based on a result detected by the biological information sensor (BIO INFO SENS) 25. The biological information sensor 25 may be provided by at least one of a blood pressure sensor, an electrocardiographic sensor, a pulse sensor, a respiratory sensor or the like. The biological information sensor 25 is able to detect at least one of a blood pressure, electrocardiographic information, pulses, or a frequency of respiration, and at least one of these informations can be used as the biological information.

The driving behavior detection unit 19 detects information related to the driving behavior carried out by the driver based on the data detected by a driving behavior sensor (BEHAV SENS) 31. The driving behavior sensor 31 may be provided by at least one of an accelerator pedal sensor, a brake pedal sensor, a steering wheel angle detector, a vehicle speed detector, or a shift position detector. The driving behavior may be indicated by at least one of depressing amount of an accelerator pedal, depressing amount of a brake pedal, rotation angle of the steering wheel, vehicle speed, acceleration, deceleration, or shift position.

The condition determination unit 17 determines a condition of the driver based on the biological information or the driving behavior made by the driver. The determination of the driver's condition based on the biological information may be carried out using a well-known method as described below. For example, when the driver is not in a good condition, the biological information changes corresponding to the condition of the driver. Thus the condition determination unit 17 is able to determine the condition of the driver by detecting a change in the biological information. Similarly, the driving behavior made by the driver changes corresponding to the condition of the driver. Thus, the driving behavior made in the bad condition is different from the driving behavior made in the normal condition. Thus, the normal driving behavior can be preliminarily set as a reference behavior, and the driving behavior detected real time can be compared with the preliminarily set normal driving behavior in order to determine the condition of the driver.

The parameter selection unit 18 selects the operation parameters used for the driving assistances corresponding to the condition of the driver. Herein, the driving assistance unit 14 performs the driving assistance with reference to the operation parameters that are preliminarily set in the parameter storing unit 15. The method for selecting parameters will be described later in detail.

The driving assistance unit 14 performs the driving assistance based on the operation parameters, which are selected corresponding to the condition of the driver. Thus, even when the driver has no self-awareness to the abnormal condition of himself or herself, the driving safety can be secured by the selection of the operation parameter corresponding to the condition of the driver by the driving assistance unit 14.

As shown in FIG. 1, the driving assistance apparatus 100 according to the present embodiment includes the driving assistance unit 14, the parameter storing unit 15, the biological information detection unit 16, the condition determination unit 17, and the parameter selection unit 18.

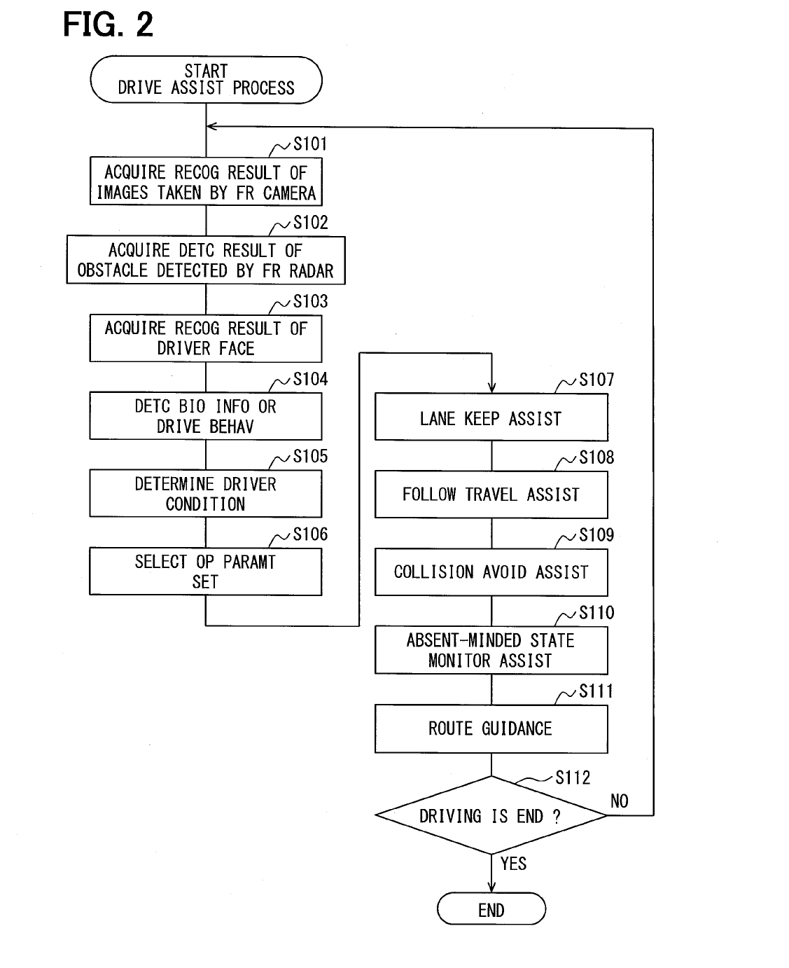

The following will describe a driving assistance process (DRIVE ASSIST PROCESS) executed by the driving assistance apparatus 100 according to the present embodiment. FIG. 2 shows a flowchart of the driving assistance process according to the present embodiment.

As shown in FIG. 2, when the driving assistance apparatus 100 starts the driving assist process, at S101, the driving assistance apparatus 100 acquires a recognition result of images from the image recognition unit 11. As described above, the image recognition unit 11 analyzes images taken by the front camera 20, and recognizes the marked lanes on the road surface, the front vehicle, and the obstacle existing ahead of the subject vehicle. Then, the driving assistance unit 14 of the driving assistance apparatus 100 acquires the recognition result from the image recognition unit 11.

At S102, the driving assistance unit 14 acquires the detection result of the obstacle existing ahead of the subject vehicle from the obstacle detection unit 12. Herein, the obstacle existing ahead of the subject vehicle is detected by the front radar 21. The image recognition unit 11 is able to recognize an accurate direction in which the obstacle exists. However, the image recognition unit 11 is unable to detect an accurate distance from the subject vehicle to the obstacle. The front radar 21 is able to recognize an accurate distance from the subject vehicle to the obstacle existing ahead of the vehicle. However, the front radar 21 is unable to detect an accurate direction in which the obstacle exists. Further, the front radar 21 is unable to recognize whether the object existing ahead of the subject vehicle is a front vehicle or an obstacle. Thus, the image recognition unit 11 and the front radar 21 work together in order to accurately recognize the obstacle existing ahead of the subject vehicle and a position of the front vehicle.

As another example, two front cameras 20 may be equipped to the vehicle in order to take images in the travelling direction of the vehicle. The two front cameras 20 are separated from each other in a width direction of the subject vehicle in order to function as a stereo camera. A distance from the subject vehicle to the obstacle or to the front vehicle may be calculated based on a parallax difference of the two front cameras 20.

At S103, the driving assistance unit 14 acquires the recognition result of the driver's face from the face image recognition unit 13. The recognition result of the driver's face includes information related to the orientation of the driver's face, the direction of the line of sight of the driver, the opening level of the eye of the driver, the frequency of blink, the speed of the blink, or the like. The opening level of the eye may be defined as a ratio of an opening width of the eye to an original width of the eye. The original width of the eye is an eye width when the user opens the eye in a normal condition. The frequency of blink indicates the number of repeated blinks per unit time. The speed of the blink may be obtained by dividing a distance the eyelid moves during a closing and opening of the eye by the time used for the moving.

At S104, the biological information detection unit 16 of the driving assistance apparatus 100 acquires the biological information of the driver from the biological information sensor 25. Alternatively, the driving behavior detection unit 19 acquires the driving behavior made by the driver from the driving behavior sensor 31. The driving assistance apparatus 100 may acquire at least one of the biological information or the driving behavior. As described above, the biological information sensor 25 may be provided by at least one of the blood pressure sensor, the electrocardiographic sensor, the pulse sensor, or the respiratory sensor. The biological information sensor 25 is able to detect at least one of the blood pressure, electrocardiographic information, pulses, and the frequency of respiration, and at least one of these informations can be used as the biological information. The driving behavior sensor 31 may be provided by at least one of the accelerator pedal sensor, the brake pedal sensor, the steering wheel angle detector, the vehicle speed detector, or the shift position detector. The driving behavior may be indicated by at least one of the depressing amount of the accelerator pedal, the depressing amount of the brake pedal, the rotation angle of the steering wheel, the vehicle speed, the acceleration of the vehicle, the deceleration of the vehicle, or the shift position of the transmission of the vehicle.

At S105, the condition determination unit 17 of the driving assistance apparatus 100 determines the condition of the driver based on at least one of the detected biological information or the detected driving behavior. For example, the condition determination unit 17 may preliminarily set a standard value of each biological information, such as the blood pressure, the pulse, the frequency of respiration. Then, the condition determination unit 17 may compare the biological information detected by the biological information detection unit 16 with the corresponding standard value that is preliminarily set. When one biological information is substantially greater than the standard value or when predetermined pieces of biological information are different from the corresponding standard values, the condition determination unit 17 determines the driver is not in a good condition.

Similarly, the normal driving behavior of the driver can be preliminarily set as a reference, and the condition determination unit 17 may compare the driving behavior detected by the driving behavior sensor 31 with the preliminarily set normal driving behavior in order to determine the condition of the driver.

At S106, the parameter selection unit 18 of the driving assistance apparatus 100 selects an operation parameter set corresponding to the condition of the driver detected at S105. Herein, the operation parameters are parameters based on which the driving assistance unit 14 carries out above-described driving assistances. The driving assistance unit 14 changes an operation mode of the driving assistance according to the corresponding operation parameters. As described above, the driving assistance unit 14 of the driving assistance apparatus 100 carries out various kinds of driving assistances. Thus, the operation parameters are set for each driving assistance. The operation parameter set is a group of the operation parameters that are used for the various kinds of the driving assistances.

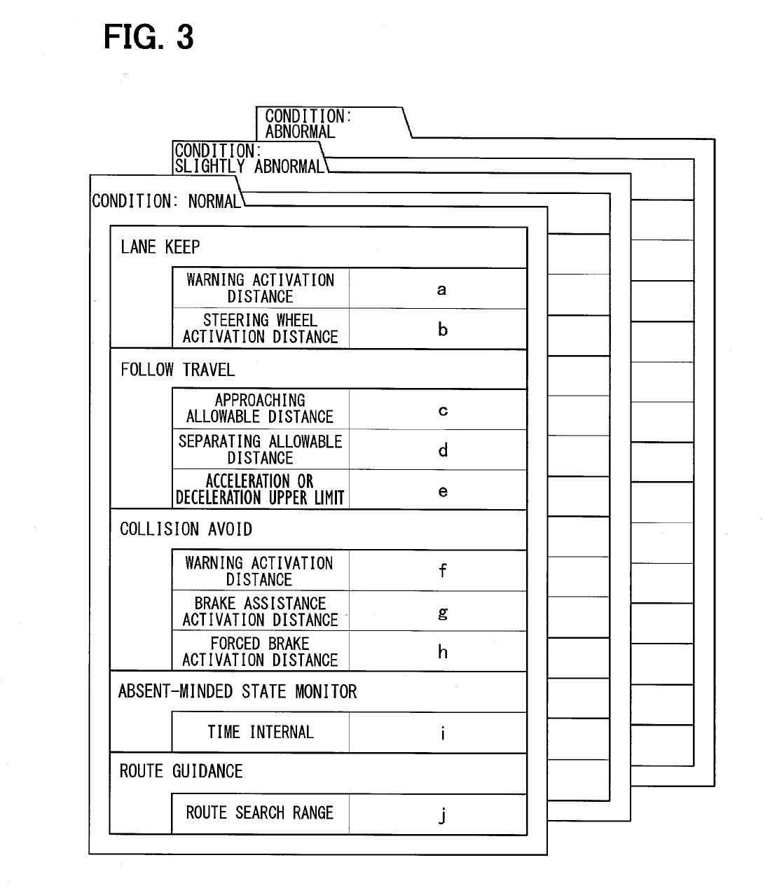

FIG. 3 shows an example of the operation parameter sets. As shown in FIG. 3, one operation parameter set includes the operation parameters for the lane keeping assistance, the operation parameters for the following travelling assistance, the operation parameters for the collision avoiding assistance, the operation parameters for the absent-minded state monitoring assistance, and the operation parameters for the route guidance assistance.

In the lane keeping assistance, a warning activation distance is set as a, and a steering wheel activation distance is set as b. Herein, a and b indicate the values of distances. The warning activation distance is a threshold distance which is used for determining whether to perform a warning to the driver about a possibility of deviation from the travelling lane. When a distance between the subject vehicle and the marked lane detected by the image recognition unit 11 becomes shorter than the warning activation distance, the possibility of the deviation of the vehicle from the travelling lane needs to be notified to the driver.

The steering wheel activation distance is a threshold value which is used for determining whether to automatically start an operation of the steering wheel. When a distance between the subject vehicle and the marked lane detected by the image recognition unit 11 becomes shorter than the steering wheel activation distance, the steering wheel is automatically and gently operated to move the vehicle to a central portion of the travelling lane. Usually, the steering wheel activation distance is set shorter than the warning activation distance.

In the lane keeping assistance, when the vehicle moves adjacent to the marked line that indicates the travelling lane of the vehicle and the distance from the subject vehicle to the marked line becomes equal to or shorter than the warning activation distance, the speaker 30 or the display device 29 performs the warning to the driver in order to notify the approach of the vehicle toward the lane.

Even though the warning is carried out to the driver, the driver continues to move the vehicle more adjacent to the marked line and the distance from the subject vehicle to the marked line becomes equal to or shorter than the steering wheel activation distance, the steering wheel is controlled to be automatically and gently rotated in a direction so that the vehicle moves to the central portion of the travelling lane.

In the following travelling assistance, an approaching allowable distance is set as c, a separating allowable distance is set as d, and an upper limit of absolute value of the acceleration or the deceleration is set as e. Herein, c and d indicate the values of distances, and e indicates a value of acceleration.

The approaching allowable distance is an allowable distance by which the subject vehicle can approach to the front vehicle during the following travelling. The separating allowable distance is an allowable distance by which the subject vehicle can be apart from the front vehicle during the following travelling. The separating allowable distance is set longer than the approaching allowable distance. During the following travelling, the speed of the subject vehicle is controlled so that the distance from the subject vehicle to the front vehicle is equal to or longer than the approaching allowable distance and equal to or shorter than the separating allowable distance. Further, an upper limit of the absolute value of the acceleration or the deceleration is set for controlling the distance from the subject vehicle to the front vehicle to be maintained within the range from the approaching allowable distance to the separating allowable distance.

In the following travelling assistance, deceleration operation is carried out in order to maintain the distance from the subject vehicle to the front vehicle longer than the approaching allowable distance at a deceleration smaller than the upper limit of the absolute value of the deceleration. Further, in the following travelling assistance, acceleration operation is carried out in order to maintain the distance from the subject vehicle to the front vehicle shorter than the separating allowable distance at an acceleration smaller than the upper limit of the absolute value of the acceleration.

In the collision avoiding assistance, a warning activation distance is set as f, a brake assistance activation distance is set as g, and a forced brake activation distance is set as h. Herein, f, g, and h indicate the values of distances.

The warning activation distance is a threshold distance which is used for determining whether to perform a warning to the driver about a possibility of collision with an obstacle existing ahead of the subject vehicle. Herein, the obstacle existing ahead of the subject vehicle includes the front vehicle. For example, when the distance from the subject vehicle to the obstacle is equal to or shorter than the warning activation distance, the possibility of collision with the obstacle needs to be notified to the driver.

The brake assistance activation distance is a threshold distance based on which a brake assistance operation for increasing a braking power needs to be activated or not. For example, when the driver depresses the brake pedal in response to an obstacle existing ahead of the subject vehicle and the distance between the subject vehicle and the obstacle is equal to or shorter than the brake assistance activation distance, the braking power obtained by the depressing on the brake pedal is increased in order to stop the subject vehicle quickly.

The forced brake activation distance is a threshold distance based on which an activation of the brake needs to be carried out or not even when the brake pedal is not depressed by the driver. For example, when the distance between the subject vehicle and the obstacle existing ahead of the subject vehicle becomes equal to or shorter than the forced brake activation distance, the braking power is forcibly generated even when the driver does not depress on the brake pedal in order to avoid the collision with the obstacle or in order to reduce a shock generated by the collision with the obstacle.

The brake assistance activation distance is set shorter than the warning activation distance, and the forced brake activation distance is set shorter than the brake assistance activation distance.

In the collision avoiding assistance, when the distance from the subject vehicle to the obstacle existing ahead of the subject vehicle becomes equal to or shorter than the warning activation distance, the speaker 30 or the display device 29 outputs a warning to the driver to notify the approaching of the subject vehicle to the obstacle. Then, when the distance from the subject vehicle to the obstacle existing ahead of the subject vehicle becomes equal to or shorter than the brake assistance activation distance, the braking power generated by the depressing on the brake pedal is increased in order to stop the vehicle quickly at an earlier time. After that, when the distance from the subject vehicle to the obstacle existing ahead of the subject vehicle further becomes equal to or shorter than the forced brake activation distance, the braking power is forcibly generated even when the driver does not depress on the brake pedal in order to stop the vehicle.

In the absent-minded state monitoring assistance, when the absent-minded state of the driver continues for a period of time, the time interval i for repeatedly warning the absent-minded state to the driver is set as the operation parameter. That is, when the user continues the driving in the absent-minded state even when the user has been warned for the absent-minded state, the warning is repeatedly carried out to the user at the preliminarily set time interval.

In the route guidance assistance, a range for searching for the route to the destination set by the driver is set as the operation parameter. That is, when the user inputs the destination and searches for a route to the destination, the route recommended to the driver may be differently set according to the searching parameter, such as a road class, a road width, or the like. In the route guidance assistance, the range for searching for the route is set as the operation parameter.

In the driving assistance apparatus 100 according to the present embodiment, the operation parameters corresponding to above-described driving assistances are preliminarily set as one operation parameter set corresponding to a condition of the driver. For example, the operation parameters corresponding to a normal condition of the driver is set as an operation parameter set for a normal condition. The operation parameters corresponding to a slightly abnormal condition of the driver is set as an operation parameter set for a slightly abnormal condition. The operation parameters corresponding to an abnormal condition of the driver is set as an operation parameter set for an abnormal condition.

The parameter storing unit 15 of the driving assistance apparatus 100 preliminarily stores the operation parameter sets corresponding to various conditions of the driver. As shown in FIG. 2, in the driving assistance process according to the first embodiment, when the condition determination unit 17 of the driving assistance apparatus 100 determines the condition of the driver at S105, the parameter selection unit 18 of the driving assistance apparatus 100 selects and acquires one of the operation parameter sets from the parameter storing unit 15 corresponding to the condition of the driver.

The driving assistance unit 14 of the driving assistance apparatus 100 carries out, based on the operation parameters included in the selected operation parameter set, the lane keeping assistance at S107, the following travelling assistance at S108, the collision avoiding assistance at S109, the absent-minded state monitoring assistance at S110, and the route guidance assistance at S111.

As described above, the operation parameters used in each driving assistance is set as one operation parameter set. Thus, by selecting the operation parameter set corresponding to the condition of the driver, the operation parameters necessary for carrying out all of the driving assistances can be selected by one time. Further, the selecting of the operation parameters can be performed with respect to each driving assistance, instead of all of the driving assistances.

At S112, the driving assistance unit 14 of the driving assistance apparatus 100 determines whether the driving of the vehicle is ended. When the driving assistance unit 14 determines that the vehicle is still in the travelling state (S112: NO), the process returns to S101. Then, the driving assistance apparatus 100 acquires a new recognition result of images from the image recognition unit 11 at S101. Then, the driving assistance apparatus 100 carries out the processes of S102 to S111 as described above.

At S112, when the driving of the vehicle is ended (S112: YES), the driving assistance unit 14 ends the driving assistance process shown in FIG. 2.

As described above, in the driving assistance process according to the first embodiment, the operation parameters for the driving assistances are selected corresponding to the condition of the driver.

Thus, in the lane keeping assistance, the warning for the possibility of the deviation from the travelling lane can be carried out at an earlier time with a degradation of the driver's condition. Similarly, the steering wheel operation assistance for avoiding the deviation from the travelling lane can be carried out at an earlier time with a degradation of the driver's condition.

In the following travelling assistance, the approaching allowable distance and the separating allowable distance are set longer with a degradation of the driver's condition compared with the distances set corresponding to a normal condition of the driver. With this configuration, an acceleration operation and deceleration operation can be prevented from being frequently carried out.

Further, the upper limit of the absolute value of the acceleration or the deceleration are set smaller with a degradation of the driver's condition compared with the upper limit of the absolution value of the acceleration or the deceleration corresponding to the normal condition of the driver. In the collision avoiding assistance, a warning for the possibility of a collision with an object, an assistance of the brake operation, or the forcible brake operation can be activated at an earlier time with a degradation of the driver's condition.

In the absent-minded state monitoring assistance, the time interval by which the warning for notifying the absent-minded state to the driver is carried out becomes shorter with a degradation of the driver's condition.

In the route guidance assistance, a route mainly including wide roads that are easy to be driven is recommended to the driver with a degradation of the driver's condition.

As described above, the operation mode of the same driving assistance is changed according to the condition of the driver instead of changing one driving assistance to a totally different driving assistance. Thus, even when the driver has no self-awareness to the abnormal condition of himself or herself, the driving assistance is carried out to secure the driving safety without providing misleading information to the driver.

The operation parameters included in each operation parameter set can be set corresponding to the condition of the driver. Thus, a flexibility of setting the operation parameters can be improved. For example, when carrying out the collision avoiding assistance, the warning activation distance and the brake assistance activation distance can be set to greater values with a degradation of the driver's condition and the forced brake activation distance can be set as a constant value regardless of a condition of the driver. With this configuration, the warning to the driver and the brake assistance can be started at an earlier time. As another example, the warning activation distance, the brake assistance activation distance, the forced brake activation distance may be set to greater values with a degradation of the driver's condition in order to activate the warning, the brake assistance, and the forcible brake operation at respective earlier timings.

### Second Embodiment

The following will describe a second embodiment of the present disclosure. In the second embodiment, the driving assistance process executed by the driving assistance apparatus 100 is different from the driving assistance process according to the first embodiment. In the first embodiment, multiple operation parameter sets are set corresponding to the various conditions of the driver in advance, and the operation parameter set corresponding to the real time condition of the driver is selected in order to carry out the various kinds of driving assistances.

In the present embodiment, the operation parameter set corresponding to the condition of the driver is not selected from multiple operation parameter sets. In the present embodiment, the operation parameters read out from one operation parameter set are adjusted corresponding to the condition of the driver, and are used in the driving assistance controls. The following will describe the driving assistance process according to the present embodiment.

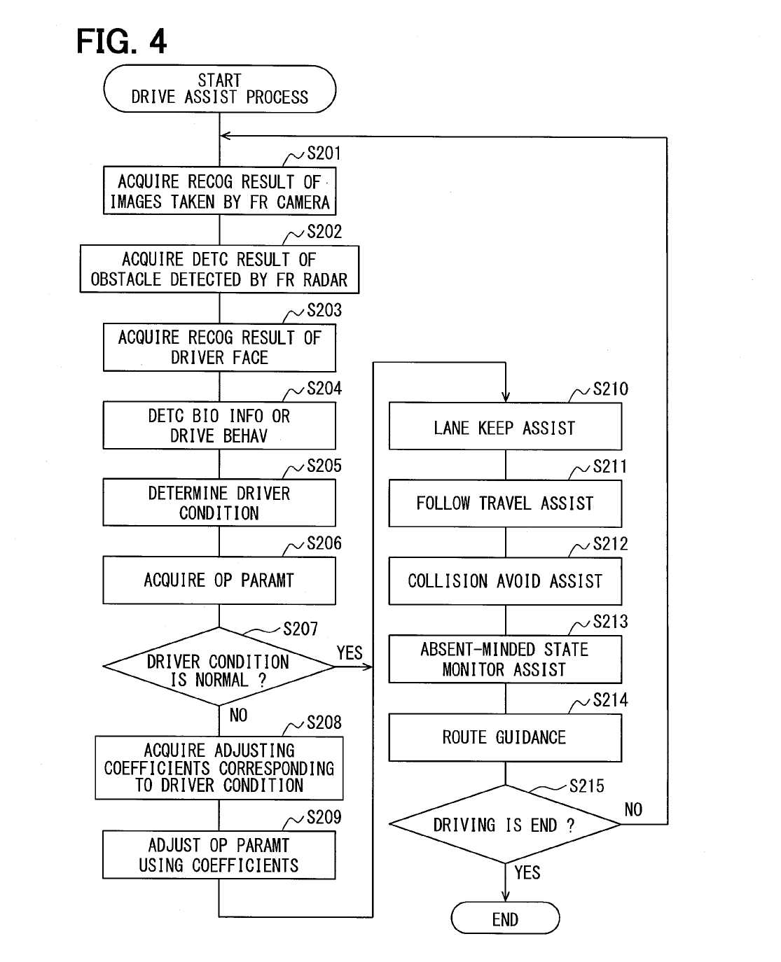

FIG. 4 is a flowchart showing the driving assistance process according to the present embodiment. In the driving assistance process according to the present embodiment, instead of selecting the operation parameter set corresponding to the condition of the driver, the driving assistance apparatus 100 reads out the operation parameters from one operation parameter set, and adjusts the operation parameters corresponding to the condition of the driver. Other parts of the second embodiment are similar to the first embodiment. The following will describe the driving assistance process according to the present embodiment with reference to FIG. 4.

As shown in FIG. 4, the driving assistance apparatus 100 acquires the recognition result of images taken by the front camera 20 at S201, and acquires the detection result of an obstacle at S202. Herein, the front radar 21 detects the obstacle existing ahead of the vehicle. At S203, the driving assistance apparatus 100 acquires the recognition result of the face images of the driver. At S204, the driving assistance apparatus 100 detects the biological information or the driving behaviors, and determines the condition of the driver at 5205.

At S206, the parameter selection unit 18 acquires the operation parameters from the parameter storing unit 15. In the present embodiment, the parameter storing unit 15 preliminarily stores operation parameters used for each of various kinds driving assistances. At S206, the parameter selection unit 18 acquires all of the operation parameters at one time.

At S207, the condition determination unit 17 further determines whether the condition of the driver is normal. When the condition determination unit 17 determines that the condition of the driver is normal (S207: YES), the driving assistance unit 14 carries out, based on the operation parameters read out from the parameter storing unit 15 at S206, the lane keeping assistance at S210, the following travelling assistance at S211, the collision avoiding assistance at S212, the absent-minded state monitoring assistance at S213, and the route guidance assistance at S214.

When the condition determination unit 17 determines that the condition of the driver is not normal (S207: NO), the parameter selection unit 18 read out adjusting coefficients of respective operation parameters at S208. In the present embodiment, the adjusting coefficients of respective operation parameters are preliminarily set corresponding to a condition of the driver, and are preliminarily stored in the parameter storing unit 15. Thus, at S208, the parameter selection unit 18 acquires, from the parameter storing unit 15, the adjusting coefficients of respective operation parameters corresponding to the condition of the driver at one time.

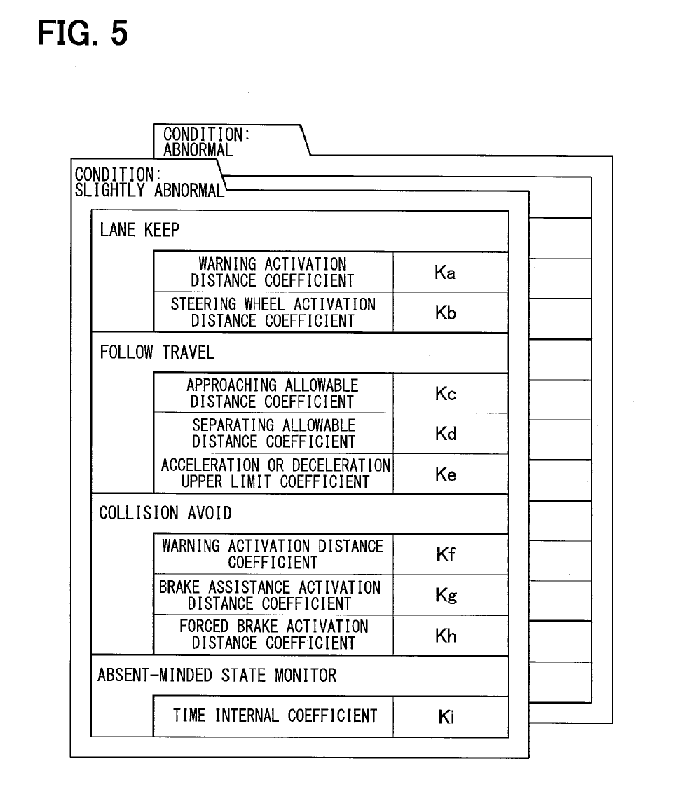

FIG. 5 shows an example of adjusting coefficient sets each of which including adjusting coefficients of respective operation parameters corresponding to a condition of the driver. The adjusting coefficient sets shown in FIG. 5 are preliminarily set and preliminarily stored in the parameter storing unit 15.

For example, in the lane keeping assistance, adjusting coefficients are set corresponding to the warning activation distance and the steering wheel activation distance as a warning activation distance adjusting coefficient Ka and a steering wheel activation distance adjusting coefficient Kb, respectively.

In the following travelling assistance, adjusting coefficients are set corresponding to the approaching allowable distance, the separating allowable distance, and the upper limit of the absolute value of the acceleration or the deceleration as an approaching allowable distance adjusting coefficient Kc, a separating allowable distance adjusting coefficient Kd, and an upper limit of the absolute value of the acceleration or the deceleration adjusting coefficient Ke, respectively.

In the collision avoiding assistance, adjusting coefficients are set corresponding to the warning activation distance, the brake assistance activation distance, and the forced brake activation distance as a warning activation distance adjusting coefficient Kf, a brake assistance activation distance adjusting coefficient Kg, and a forced brake activation distance adjusting coefficient Kh, respectively.

In the absent-minded state monitoring assistance, an adjusting coefficient is set corresponding to the time interval as a time interval adjusting coefficient Ki, by which the warning for notifying of the absent-minded state is carried out, as an interval time adjusting coefficient.

The adjusting coefficients for the driving assistances are stored as one adjusting coefficient set corresponding to a condition of the driver. In the driving assistance process according to the present embodiment, when the condition determination unit 17 determines that the condition of the driver is not normal (S207: NO), at S208, the parameter selection unit 18 reads out an adjusting coefficient set corresponding to the condition of the driver detected at S207.

Then, the parameter selection unit 18 adjusts the operation parameters using the respective adjusting coefficients, which are read out corresponding to the condition of the driver. For example, in the lane keeping assistance, the warning activation distance and the steering wheel activation distance are the necessary operation parameters for carrying out the driving assistance. Thus, the adjusting coefficient of the warning activation distance is set as Ka and the adjusting coefficient of the steering wheel activation distance is set as Kb corresponding to a slightly abnormal condition of the driver as shown in FIG. 5.

At S209, the parameter selection unit 18 multiplies the warning activation distance by the corresponding adjusting coefficient Ka, and obtains the adjusted warning activation distance. The parameter selection unit 18 further multiplies the steering wheel operation activation by the corresponding adjusting coefficient Kb, and obtains the adjusted steering wheel operation activation. Similar calculation is carried out for adjusting each of the operation parameters, and a detailed description will be omitted herein.

However, in the route guidance assistance, the adjusted operation parameter cannot be obtained by just simply multiplying the operation parameter by the adjusting coefficient. Thus, in the present embodiment, the operation parameter of the route guidance assistance is not adjusted. As another example, the operation parameter of the route guidance can be changed to a predetermined operation parameter corresponding to the condition of the driver as described in the first embodiment.

After adjusting all of the operation parameters at S209, the driving assistance unit 14 carries out, based on the adjusted operation parameters, the lane keeping assistance at S210, the following travelling assistance at S211, the collision avoiding assistance at S212, the absent-minded state monitoring assistance at S213, and the route guidance assistance at S214.

At S215, the driving assistance unit 14 of the driving assistance apparatus 100 determines whether the driving of the vehicle is ended. When the driving assistance unit 14 determines that the vehicle is still in the travelling state (S215: NO), the process returns to S201. Then, the driving assistance apparatus 100 acquires a new recognition result of images from the image recognition unit 11 at S201. Then, the driving assistance apparatus 100 carries out the processes of S202 to S215 as described above.

At S215, when the driving of the vehicle is ended (S215: YES), the driving assistance unit 14 ends the driving assistance process shown in FIG. 4.

As described above, in the driving assistance process according to the second embodiment, the operation parameters used in the driving assistances can be adjusted corresponding to the condition of the driver. Thus, as described above, the operation mode of the same driving assistance is changed according to the condition of the driver instead of changing one driving assistance to a totally different driving assistance. Thus, even when the driver has no self-awareness to the abnormal condition of himself or herself, the driving assistance is carried out to secure the driving safety without providing misleading information to the driver.

In the present embodiment, the operation parameters used in the various driving assistances are adjusted corresponding to the condition of the driver and are used in the various driving assistances after adjustment. Thus, the parameter storing unit has no need to store multiple operation parameter sets corresponding to different conditions of the driver. Thus, a memory capacity of the parameter storing unit 15 can be used effectively.

### Third Embodiment

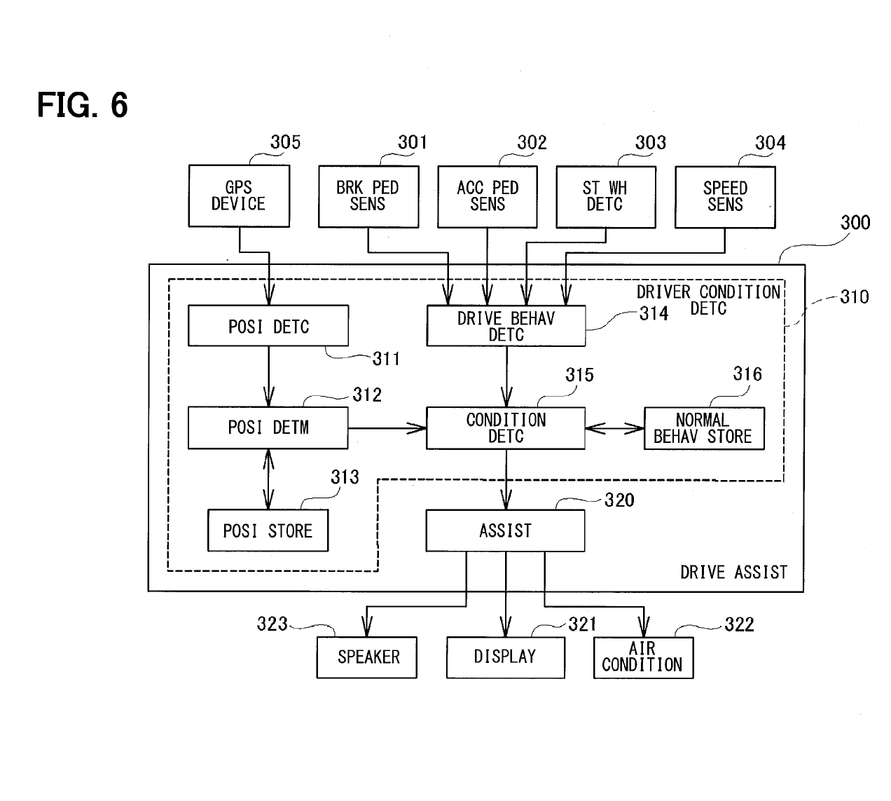

The following will describe a driving assistance apparatus (DRIVE ASSIST) 300 according to a third embodiment of the present disclosure with reference to FIG. 6. As shown in FIG. 6, the driving assistance apparatus 300 according to the present embodiment includes a driver condition detection apparatus (DRIVER CONDITION DETC) 310 and a driving assistance unit (ASSIST) 320. Specifically, the driving assistance apparatus 300 includes a position detection unit (POSI DETC) 311, a position determination unit (POSI DETM) 312, a position storing unit (POSI STORE) 313, a driving behavior detection unit (DRIVE BEHAV DETC) 314, a condition detection unit (CONDITION DETC) 315, a normal driving behavior storing unit (NORMAL BEHAV STORE) 316, and the driving assistance unit 320.

Each of the above-described units is a functional unit of the driving assistance apparatus 300, and does not indicate that the driving assistance apparatus 300 is physically divided into above-described nine units. Each or any combination of units described above can be achieved as (i) a software section implemented by execution of a program by a central processing unit, (ii) a software section in combination with a hardware unit (e.g., computer) or (iii) a hardware section, including or not including a function of a related apparatus; furthermore, the hardware section (e.g., an electric circuit including a large-scale integrated circuit and a memory, a hard-wired logic circuit) may be constructed inside of a microcomputer.

The driving assistance apparatus 300 or the driver condition detection apparatus 310 is provided by a microcomputer including a central processing unit, a real-only memory, and a random access memory. A program executed by the central processing unit provides a function of each unit included in the driving assistance apparatus 300 or in the driver condition detection apparatus 310.

The position detection unit 311 is connected with a GPS device 305. The GPS device 305 may be included in a navigation system (not shown). The position detection unit 311 detects a present position of the subject vehicle based on the information acquired from the GPS device 305.

As another example, the position detection unit 311 may detect the present position of the vehicle based on position information acquired from a road side device (not shown) by communicating with the road side device positioned at a road side.

The position determination unit 312 determines whether the present position of the subject vehicle, which is detected by the position detection unit 311, is equal to a target position for detecting a condition of the driver. Herein, the target position for detecting a condition of the driver is also referred to as a detection target position.

The position storing unit 313 preliminarily sets detection target positions and stores information of the detection target positions. The position determination unit 312 may determine whether the present position of the subject vehicle is equal to the detection target position by comparing the present position of the vehicle with the information of the detection target positions stored in the position storing unit 313. When the position determination unit 312 determines that the present position of the subject vehicle is equal to the detection target position, the position determination unit 312 transmits, to the condition detection unit 315, information indicating that the present position of the subject vehicle is equal to the detection target position.

When the condition detection unit 315 receives the information indicating that the present position of the subject vehicle is equal to the detection target position, the condition detection unit 315 controls the driving behavior detection unit 314 to acquire the driving behavior made by the driver to the subject vehicle.

As shown in FIG. 6, the driving behavior detection unit 314 is connected with a brake pedal sensor (BRK PED SENS) 301 detecting a depressing amount of the brake pedal, an accelerator pedal sensor (ACC PED SENS) 302 detecting a depressing amount of the accelerator pedal, a steering wheel angle detector (ST WH DETC) 303 detecting a rotation angle of the steering wheel, and a vehicle speed sensor (SPEED SENS) 304 detecting a speed of the vehicle. The driving behavior detection unit 314 detects a driving behavior of the driver based on at least one of multiple time series data output from the multiple sensors 301 to 304. Thus, the driving behavior includes an operation made by the driver in order to control a movement of a vehicle, and further includes a behavior of the vehicle corresponding to the operation made by the driver to the vehicle.

The driving behavior detection unit 314 may detect a driving operation made by the driver as the driving behavior. The driving behavior detection unit 314 may detect an operation made by the driver on an accelerator pedal of the vehicle as the driving behavior. The driving behavior detection unit 314 may detect an operation made by the driver on a brake pedal of the vehicle as the driving behavior. The driving behavior detection unit 314 may detect an operation made by the driver on a steering wheel of the vehicle as the driving behavior. The driving behavior detection unit 314 may detect a behavior of the vehicle in response to a driving operation made by the driver as the driving behavior. The driving behavior detection unit 314 may detect a start behavior made at the detection target position for starting the vehicle from a stop state as the driving behavior. The driving behavior detection unit 314 may detect a stop behavior made at the detection target position for stopping the vehicle from a travelling state as the driving behavior.

When the condition detection unit 315 acquires the driving behavior made at the detection target position from the driving behavior detection unit 314, the condition detection unit 315 compares the acquired driving behavior with a normal driving behavior stored in the normal driving behavior storing unit 316 in order to detect the condition of the driver. Herein, the normal driving behavior is a driving behavior normally performed by the driver at the detection target position. The normal driving behavior may be obtained by preliminarily detecting the driving behavior made by the driver at the corresponding detection target position while the driver is in the normal condition. The condition of the driver can be acquired based on a comparison result of the real time driving behavior made by the driver at the preliminarily set detection target position with the normal driving behavior at the detection target position.

When the driver is determined to be in an abnormal condition, the condition detection unit 315 transmits information indicating the abnormal condition of the driver to the driving assistance unit 320.

When the driving assistance unit 320 receives, from the condition detection unit 315, the information indicating the abnormal condition of the driver, the driving assistance unit 320 performs a warning for notifying of the abnormal condition to the driver by controlling a speaker 323 to output audio information or by controlling a display device (DISPLAY) 321 to output image information. As another example, the driving assistance unit 320 may perform a warning for notifying of the abnormal condition to the driver by controlling an air conditioning device (AIR CONDITION) 322 to blow an air toward the driver. The operation parameters of the collision avoiding assistance, the lane keeping assistance, the following travelling assistance may be set with consideration of the condition of the driver.

With the driver condition detection apparatus 310 according to the present embodiment, the condition of the driver can be detected based on the driving behavior of the driver made to the subject vehicle.

Thus, the driver is not required to wear any sensors for detecting the biological information, such as the heart rate, the pulse, and the blood pressure. Further, the condition of the driver can be detected using the devices which have been already equipped to the vehicle. Herein, the devices may include the device for detecting the present position of the vehicle, such as the GPS device 305, and the sensors for detecting the driving behavior made by the driver, such as the brake pedal sensor 301 or the like. Thus, a complication of a vehicle's structure and a complication of a control of the devices can be suppressed.

Further, the detected condition of the driver has a sufficiently high accuracy. In the prior art, the condition of the driver to be referred for carrying out the driving assistance is detected based on an analysis result of the driver's face images or the driver's biological information, such as the heart rate, the pulse, and the blood pressure. In the present embodiment, the condition of the driver to be referred for carrying out the driving assistance is detected based on the actual driving behavior made by the driver. Thus, the detection result may directly indicate the condition of the driver, and has a higher accuracy.

The following will describe the reasons why the detection result based on the driving behavior more directly indicates the condition of the driver and has a higher accuracy compared with the prior art.

The following will describe the detection of the condition of the driver based on the actual driving behavior made by the driver.

As described above, according to the prior art, the condition of the driver to be referred for carrying out the driving assistance is detected based on the driver's biological information, such as the heart rate, the pulse, and the blood pressure. In this prior art, the driver is determined to be in an abnormal condition when a parameter of the biological information goes beyond a normal range. In another example, when a drowsiness or an absent-minded state of the driver is detected as the condition of the driver, an analysis result of the driver's face images is usually used to determine the condition of the driver according to the prior art. In this prior art, when a parameter of the analysis result goes beyond a normal range, the driver is determined to be in an abnormal condition.

As well known, even when the biological information of the driver, such as the heart rate, goes beyond the normal range, the abnormal biological information does not always adversely affect the driving behavior made by the driver. Thus, the information indicating that the parameter of the biological information goes beyond the normal range just indicates an occurrence possibility of an adverse effect to the driving behavior. Since the information indicating the adverse effect to the driving behavior is more direct than the information indicating the occurrence possibility of the adverse effect to the driving behavior, the detection result obtained based on the driving behavior has a higher accuracy compared with the detection result obtained based on the analysis result of the biological information or the face images.

The information indicating the occurrence possibility of the adverse effect to the driving behavior is also important for securing a driving safety in a preventive manner. However, when the adverse effect is occurred to the driving behavior, the driving safety is directly threatened by the adverse effect. Thus, the information indicating the adverse effect appeared in the driving behavior is considered more important than the information indicating the occurrence possibility of the adverse effect to the driving behavior.

The similar principle is applied to the technology for detecting drowsiness or the absent-minded state of the driver. Specifically, even when the driver feels drowsiness or be in an absent-minded state, the drowsiness or the absent-minded state does not always appear in the driving behavior made by the driver. Since the information indicating the adverse effect appeared in the driving behavior is more direct than the information indicating whether the driver feels drowsiness or be in an absent-minded state, the detection result obtained based on the driving behavior has a higher accuracy and higher reliability compared with the detection result obtained based on the information indicating whether the driver feels drowsiness or be in an absent-minded state.

Thus, compared with the prior art in which the condition of the driver is determined based on the biological information of the analysis result of the driver's face images, the determination of the driver's condition based on the change in the driving behavior has a higher accuracy and a higher reliability. Herein, the change in the driving behavior of the driver may be caused by an abnormal condition of the driver, such as the drowsiness or the absent-minded state.

However, the method for determining the driver's condition based on the change in the driving behavior has not been studied with seriousness until now. The abnormal condition of the driver may adversely affect the driving behavior. However, except the abnormal condition of the driver, the driving behavior may also be affected by external factors, such as a width or a shape of the travelling road, a state of the road surface, or a traffic situation. Further, the external factors affect the driving behavior of the driver more greatly than the abnormal condition of the driver. Thus, a detection of the change in the driving behavior caused by the abnormal condition of the driver is considered to be difficult.

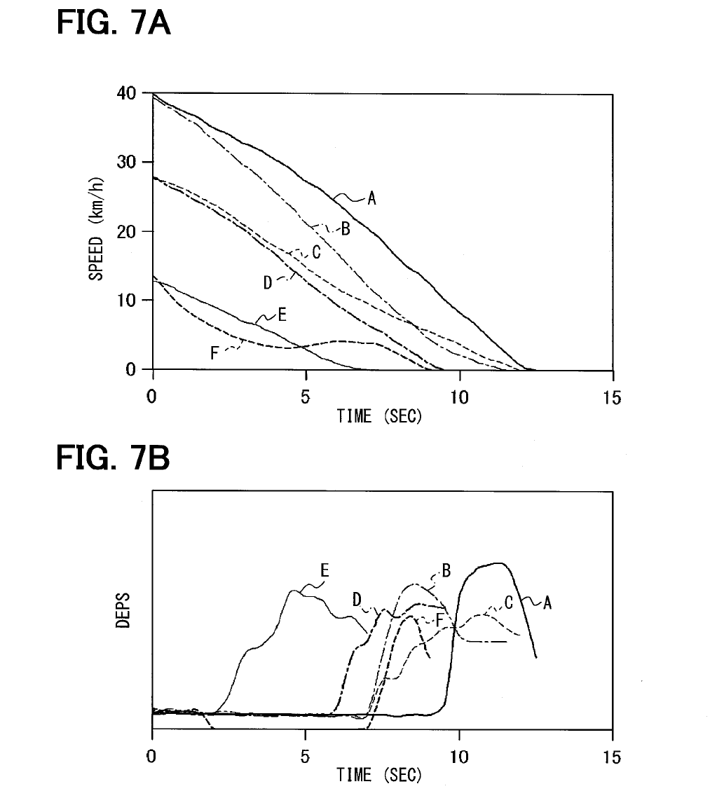

FIG. 7A and FIG. 7B are diagrams showing detection results of driving behavior, specifically a stop behavior, from a time when a depressing operation made by the driver on the brake pedal to a stop of the vehicle. All of the stop behaviors shown in FIG. 7A and FIG. 7B are made by the same driver, and the positions at which the vehicle stops are different from one another. Specifically, FIG. 7A shows detection results of a vehicle speed from a time when a depressing operation made by the driver on the brake pedal to a stop of the vehicle, and FIG. 7B shows detection results of a depressing amount (DEPS) of the brake pedal from the time when the depressing operation made by the driver on the brake pedal to the stop of the vehicle.

FIG. 7A and FIG. 7B show the stop behaviors A, B, C, D, E, and F of the subject vehicle at six different positions. Specifically, as shown in FIG. 7A, the vehicle speeds are detected from when the depressing operation is made by the driver on the brake pedal to when the vehicle speed decreases to zero after the depressing on the brake pedal. As shown in FIG. 7B, the depressing amounts of the brake pedal are detected from when the depressing operation is made by the driver on the brake pedal to when the vehicle makes a complete stop. As shown in FIG. 7A and FIG. 7B, the changes in the vehicle speeds are totally different from one another, and the changes in the depressing amounts are totally different from one another. This is because the positions at which the stop behaviors are detected are different from one another and the road surface state or the traffic situation are totally different from one another. Thus, the stop behaviors made by the driver are different from one another.

The following will describe the detection of the condition of the driver based on the driving behavior made by the driver.

As described above, the driving behavior changes with the road surface state, the traffic situation, and the time at which the driving behavior is made. That is, when the road surface state and the traffic situation are the same, the condition of the driver can be detected based on the driving behavior made by the driver. Actual stop behaviors made at the same intersection are detected.

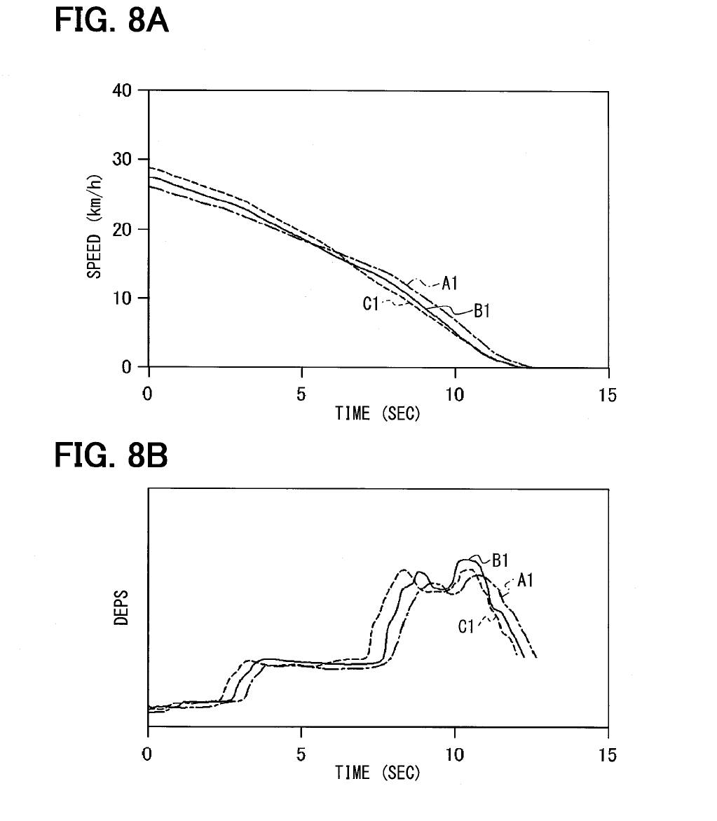

FIG. 8A and FIG. 8B are diagrams showing detection results of the stop behavior made by the same driver at the same intersection. The intersection at which the stop behavior is detected is a position at which a road having less traffic is joined to a wider road. Since there is no traffic light at the intersection, when the vehicle enters the wide road, the vehicle is required to stop temporarily before entering the wider road for confirming the traffic of the wider road. Specifically, FIG. 8A shows detection results of vehicle speeds detected from when the depressing operation is made by the driver on the brake pedal to when the vehicle makes a complete stop. FIG. 8B shows detection results of depressing amounts of the brake pedal detected from when the depressing operation is made by the driver on the brake pedal to when the vehicle makes a complete stop.

FIG. 8A and FIG. 8B show three detection results A1, B1, C1, which are detected on three different days, respectively. The vehicle speed detected at the time when the depressing operation is made by the driver on the brake pedal, the decrease of the vehicle speed after the depressing operation, and the depressing amount of the brake pedal until the stop of the vehicle are slightly different from day to day. However, the detection results A1, B1, C1 detected on three different days generally have similar tendencies.

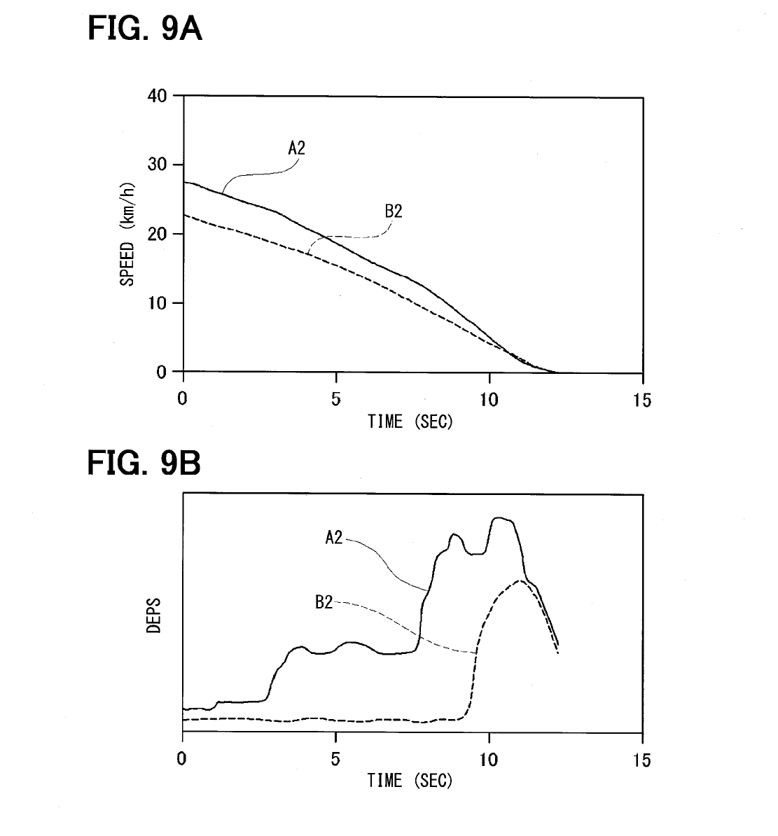

An actual stop behavior made at the same intersection is detected when the driver is in an abnormal condition as shown in FIG. 9A and FIG. 9B. The detection position and the driver are the same with the detection corresponding to FIG. 8A and FIG. 8B. In FIG. 9A, the detection results shown by the line A2 is detected under the normal condition of the driver after taking a sufficient sleep, and the detection result shown by the line B2 is detected under the abnormal condition of the driver without taking any sleep during the whole night.

Specifically, FIG. 9A shows detection results of vehicle speeds detected from when the depressing operation is made by the driver on the brake pedal to when the vehicle makes a complete stop. FIG. 9B shows detection results of depressing amounts of the brake pedal detected from when the depressing operation is made by the driver on the brake pedal to when the vehicle makes a complete stop.

In FIG. 9A and FIG. 9B, the stop behavior in the normal condition shown by the line A2 is substantially different from the stop behavior in the abnormal condition shown by the line B2. For example, as shown in FIG. 9B, in the abnormal condition, the depressing amount of the brake pedal sharply increases at a time immediately before the stop of the vehicle. However, in the normal condition, the brake pedal is depressed by the driver at a point, which is prior to the stop of the vehicle by a period of time.

Further, when the driver is in the normal condition, the depressing amount of the brake pedal is slightly adjusted by the driver from a period of time before the stop of the vehicle. However, in the abnormal condition of the driver, the slight adjustment of the depressing amount of the brake pedal is not appeared in the detection result shown by the line B2.

Further, when the driver is in the normal condition, the depressing amount of the brake pedal is slightly adjusted by the driver immediately before the stop of the vehicle. However, in the abnormal condition of the driver, the slight adjustment of the depressing amount of the brake pedal is not appeared in the detection result shown by the line B2.

In addition, the depressing amount of the brake pedal in the abnormal condition is smaller than the depressing amount of the brake pedal in the normal condition. This is caused by the lower vehicle speed in the abnormal condition compared with the vehicle speed in the normal condition as shown in FIG. 9A.

As described above, by properly setting the detection positions, the condition of the driver can be detected based on the driving behavior made by the driver. The same detection is carried out to the driving behavior of the driver when the driver starts driving of the vehicle.

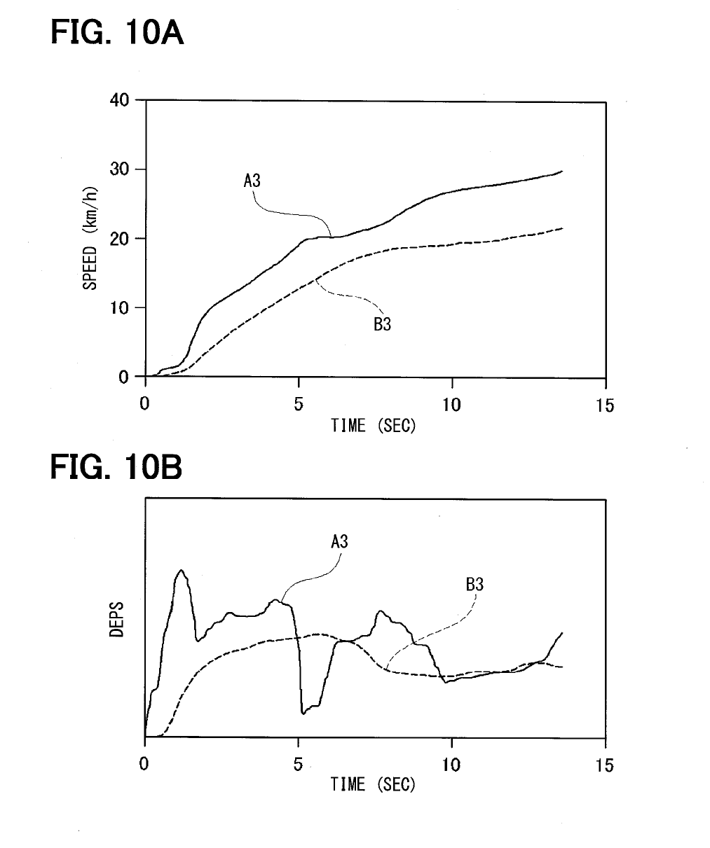

FIG. 10A and FIG. 10B are diagrams showing detection results of a driving behavior, specifically a start behavior, when traffic light at an intersection turns from red or yellow to green. Suppose that the intersection usually has small amount of traffic. In FIG. 10A, the detection result shown by a line A3 is detected under the normal condition of the driver after taking a sufficient sleep, and the detection result shown by a line B3 is detected under the abnormal condition of the driver without taking any sleep during the whole night. FIG. 10A shows detection results of vehicle speeds detected from when the driver releases the brake pedal, and FIG. 10B shows detection results of depressing amounts of the accelerator pedal detected from when the driver releases the brake pedal.

In FIG. 10A and FIG. 10B, the start behavior in the normal condition shown by the line A3 is substantially different from the start behavior in the abnormal condition shown by the line B3. As shown in FIG. 10A, in the normal condition, the vehicle speed increases quickly compared with the abnormal condition.

Further, as shown by the line A3 in FIG. 10B, in the normal condition, the driver depresses on the accelerator pedal right after releasing of the brake pedal. However, as shown by the line B3, in the abnormal condition, the driver depresses on the accelerator pedal after an elapse of time from the releasing of the brake pedal.

When the driver is in the normal condition, the depressing amount on the accelerator pedal is adjusted frequently by a substantially great amount. However, when the driver is in the abnormal condition, the changing frequency and the changing amount of the depressing amount on the accelerator pedal is smaller than the normal condition.

As described above, the external factors cause the changes of the detection result, such as the width or the shape of the road, the state of the road surface, or the situation of the traffic can be removed by properly setting the detection position. Thus, the condition of the driver can be detected based on the different driving behaviors at a sufficiently high accuracy. In the start behavior, the vehicle speed at the detection start point and the detection start point are always the same if the detection is carried out at the same detection position. Thus, the accuracy of the detection result can be further improved without being affected by the external factors.

In the driving assistance apparatus 300 and the driver condition detection apparatus 310 according to the present embodiment, the condition of the driver is detected based on the driving behavior made by the driver as described above and the driving assistance can be carried out corresponding to the detected condition of the driver.

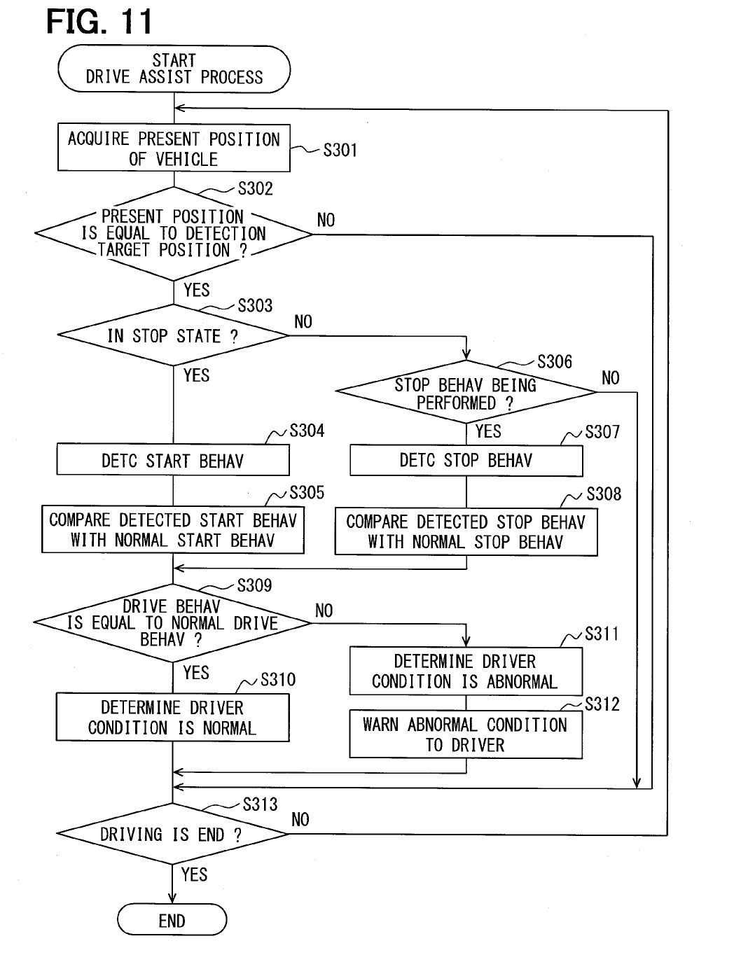

The following will describe a driving assistance process (DRIVE ASSIST PROCESS) according to the present embodiment with reference to FIG. 11. FIG. 11 is a flowchart showing the driving assistance process executed by the driving assistance apparatus 300 according to the present embodiment by detecting the condition of the driver.

At S301, the position detection unit 311 acquires the present position of the subject vehicle. Specifically, the position detection unit 311 acquires the present position of the subject vehicle from the GPS device 305. As another example, the position detection unit 311 may acquire the present position of the subject vehicle from the road side device by wirelessly communicating with the road side device positioned on a road side.

At S302, the position determination unit 312 determines whether the present position of the subject vehicle is a detection target position set for detecting a condition of the driver. As described above, by properly setting the detection target position, the condition of the driver can be detected based on the driving behavior made at the detection target position. Thus, in the driving assistance apparatus 300 and the driver condition detection apparatus 310, the detection target position is preliminarily set, and the position determination unit 312 determines whether the present position of the vehicle is equal to the detection target position.

As another example, multiple detection target positions may be set within a predetermined range from the residence of the driver or from the parking space of the vehicle. As described above, the abnormal condition of the driver is not always appeared in the driving behavior. By setting multiple detection target positions, a possibility of detecting the abnormality occurrence in the driving behavior can be increased, and accordingly, a possibility of detecting the abnormal condition of the driver can be increased. The detection target positions are set around the residence of the driver or around the parking space of the vehicle. Thus, the abnormal condition of the driver can be detected at an earlier time after the driver starts the driving of the vehicle. Further, the detection target position is not limited to a spot on the road, but also includes an area.

At S302, when the position determination unit 312 determines that the present position of the subject vehicle is not equal to the preliminarily set detection target position (S302: NO), the driving assistance apparatus 300 determines whether the driving of the vehicle is ended at S313. When the driving of the vehicle is not ended (S313: NO), the process returns to S301 and a new present position of the vehicle is acquired at S301.

At S302, when the position determination unit 312 determines that the present position of the subject vehicle is equal to the preliminarily set detection target position (S302: YES), the driving assistance apparatus 300 determines whether the subject vehicle is in a stop state at S303. Specifically, the driving assistance apparatus 300 may determine whether the subject vehicle is in a stop state or not based on an output signal from the vehicle speed sensor 304.

When the driving assistance apparatus 300 determines that the subject vehicle is in a stop state at S303 (S303: YES), the driving behavior detection unit 314 detects a start behavior of the vehicle as the driving behavior at S304. That is, the driving behavior detection unit 314 detects the vehicle speed and the depressing amount of the accelerator pedal after the releasing of the brake pedal. The detected depressing amount of the accelerator pedal and the vehicle speed are detected in time series. Further, the depressing amount of the brake pedal or the rotation angle of the steering wheel can be detected in time series as the driving behavior. Further, the acceleration or the deceleration of the vehicle can be calculated based on the speed of the subject vehicle, and can be used as the driving behavior. Usually, a vehicle includes the brake pedal sensor 301, the accelerator pedal sensor 302, the steering wheel angle detector 303, and the vehicle speed sensor 304. Thus, the time series data output from at least one of these sensors can be detected with ease without complicating a vehicle configuration or without complicating a control to the vehicular devices.

At S305, the condition detection unit 315 compares the detected start behavior with the normal start behavior preliminarily stored in the normal driving behavior storing unit 316. The following will describe an example of a method for comparing the detected start behavior with the normal start behavior. As shown by the line A3 in FIG. 10B, a graph showing the depressing amount of the accelerator pedal during the normal condition of the driver over time may be stored as the normal start behavior. Then, the condition detection unit 315 may calculate a correlation between the graph showing the detected depressing amount of the accelerator pedal during the start behavior and the graph stored as the normal start behavior.

As another example, the detected start behavior may be compared with the normal start behavior by comparing feature values of the normal start behavior with the feature values of the detected feature values. The feature values may include a period of time from when the driver releases the brake pedal and to when the depressing amount of the accelerator pedal increases to a predetermined level. The feature values may include the number indicating how many times the depressing amount of the accelerator pedal is adjusted. The feature values may include the depressing amount of the accelerator pedal being adjusted.

When the driving assistance apparatus 300 determines that the subject vehicle is not in a stop state at S303 (S303: NO), the driving behavior detection unit 314 determines whether the driver intends to stop the vehicle, that is, whether the stop behavior of the vehicle is being carried out at S306. For example, when (i) the vehicle speed has simply been decreased during an immediately prior period of time, (ii) the present vehicle speed is lower than a predetermined speed, and (iii) the present depressing amount of the accelerator pedal is equal to zero, the driving assistance apparatus 300 may determine that the stop behavior of the vehicle is being carried out.

At S306, when the driving behavior detection unit 314 determines that the stop behavior of the vehicle is being carried out (S306: YES), the driving behavior detection unit 314 detects the stop behavior of the vehicle. The driving behavior detection unit 314 may detect the depressing amount of the brake pedal or the vehicle speed in time series as the stop behavior. As another example, the driving behavior detection unit 314 may detect the depressing amount of the accelerator pedal or the rotation angle of the steering wheel in time series as the stop behavior.

At S308, the condition detection unit 315 compares the detected stop behavior with the normal stop behavior that is preliminarily stored. A method for comparing the detected stop behavior with the normal stop behavior is similar to the method for comparing the detected start behavior with the normal start behavior as described above. The comparing of the detected stop behavior with the normal stop behavior may be carried out using various methods other than above-described method.

At S309, the condition detection unit 315 determines whether the driving behavior is equal to the normal driving behavior based on a comparison result of the detected driving behavior with the normal driving behavior. As described above, the driving behavior may include the start behavior and the stop behavior. For example, when the comparison is made by calculating the correlation between the graph showing the detected driving behavior and the graph showing the normal driving behavior, the condition detection unit 315 may determine that the detected driving behavior is equal to the normal driving behavior when the correlation is equal to or greater than a predetermined threshold.

At S309, when the condition detection unit 315 determines that the detected driving behavior is equal to the normal driving behavior (S309: YES), the condition detection unit 315 determines that the driver is in a normal condition at S310. In this case, the driving assistance apparatus 300 does not carry out any warning to the driver and proceeds to S313. At S313, the driving assistance apparatus 300 determines whether the driving of the vehicle is ended.

At S309, when the condition detection unit 315 determines that the detected driving behavior is different from the normal driving behavior (S309: NO), the condition detection unit 315 determines that the driver is in an abnormal condition at S311. Then, at S312, the driving assistance apparatus 300 warns the abnormal condition of the driver to the driver. The driving assistance apparatus 300 may perform the warning by controlling the speaker 323 to output audio information or by controlling the display device 321 to output image information. As another example, the driving assistance apparatus 300 may perform a warning for the abnormal condition to the driver by controlling the air conditioning device 322 to blow an air toward the driver. The driving assistance may also be carried out in different ways, not limited to above-described manners.

After warning the abnormal condition to the driver at S312, the driving assistance apparatus 300 determines whether the driving of the vehicle is ended at S313.

When the present position of the subject vehicle is not equal to the detection target position (S302: NO) or the subject vehicle passes through the detection target position without stopping by some reasons (S306: NO), the detection of the driving behavior is not carried out and only the stop of the vehicle is determined at S313.

At S313, when the driving of the vehicle is not ended (S313: NO), the process returns to S301 and a new present position of the vehicle is acquired at S301, and above-described processes are repeatedly carried out. When the driving of the vehicle is ended (S313: YES), the driving assistance apparatus 300 ends the process shown in FIG. 11.

As described above, in the driving assistance process according to the present embodiment, the condition of the driver can be determined based on the driving behavior. Thus, the driver is not required to wear any sensors for detecting the heart rate, the pulse, and the blood pressure. Further, the driving behavior may be detected using the sensors have already been equipped to the vehicle. The sensors may include the brake pedal sensor 301, the accelerator pedal sensor 302, the steering wheel angle detector 303, the vehicle speed sensor 304, or the like. Thus, the detection signals output from the sensors can be detected with ease without complicating a vehicle configuration or complicating a control to the vehicular devices.

The condition of the driver detected based on the driving behavior has a sufficiently high accuracy and high reliability. With the configuration of the present embodiment, driving assistance can be carried out in a more direct way and more important information is provided to the driver compared with a well-known driving assistance method.

In the foregoing embodiments, the start behavior and the stop behavior are described as examples of the driving behavior. Since the start behavior is a driving behavior starts from a vehicle speed of 0 km/h, the conditions related to the vehicle speed can be easily set the same. Similar to the start behavior, since the stop behavior is a driving behavior ends when the vehicle speed becomes 0 km/h, the conditions related to the vehicle speed can be easily set the same. Thus, in any case, the start behavior and the stop behavior are less likely to be affected by external factors.

The driving behavior made in response to a left turn of a right turn of the vehicle may also be used as the driving behavior other than the start behavior or the stop behavior. In this kind of driving behavior, the condition of the driver may appear in a correlation between a time point at which the driver depresses on the accelerator pedal or on the brake pedal and a time point at which the driver operates the steering wheel. Thus, the condition of the driver can be detected at a high accuracy based on the correlation between the time point at which the driver depresses on the accelerator pedal or on the brake pedal and the time point at which the driver operates the steering wheel.

### Fourth Embodiment

The following will describe a driving assistance apparatus according to a fourth embodiment of the present disclosure. The following will mainly describe a part of the driving assistance apparatus according to the present embodiment, which is different from the third embodiment. The same reference symbols are used for the same or equivalent part with the third embodiment.

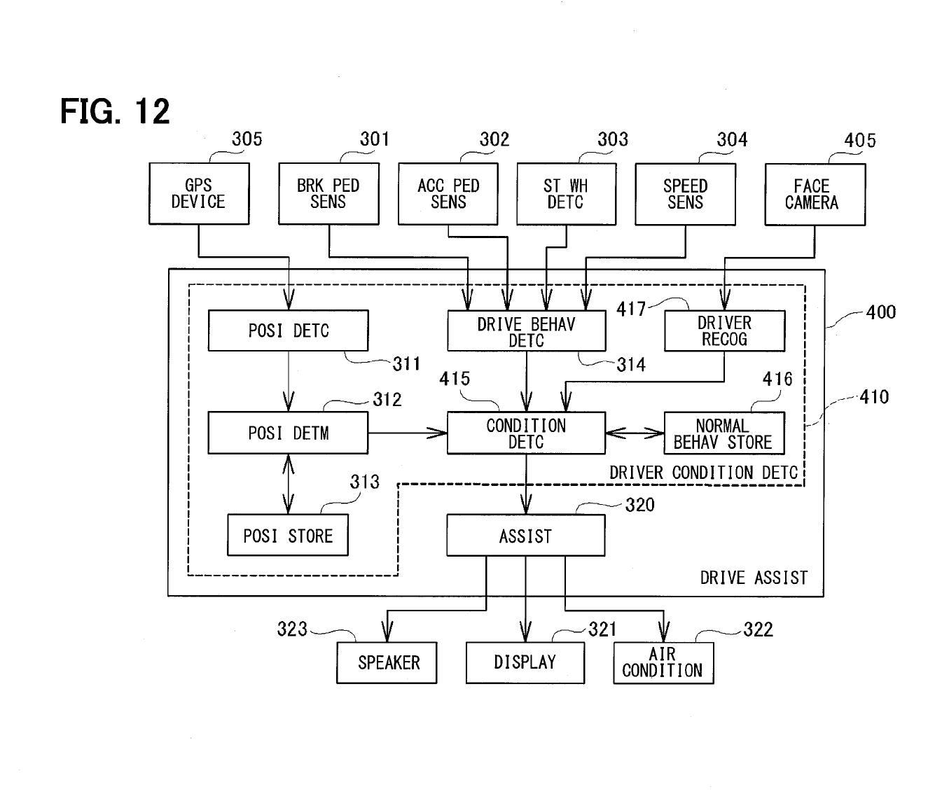

As shown in FIG. 12, the driving assistance apparatus 400 according to the present embodiment includes a driver condition detection apparatus 410. The driving assistance apparatus 400 according to the present embodiment is different from the driving assistance apparatus 300 according to the third embodiment at the following points. The driver condition detection apparatus 410 of the driving assistance apparatus 400 includes a driver recognition unit (DRIVER RECOG) 417 and a normal driving behavior storing unit 416. The normal driving behavior storing unit 416 stores multiple normal driving behaviors for respective drivers.

Usually, the abnormal condition of the driver affects the driving behavior more greatly than the difference of the drivers. Thus, difference of the drivers is not considered in the above-described embodiments when detecting the condition of the driver. However, the driving behavior is different from one driver to another driver. Thus, the accuracy of the detected condition of the driver may be further improved by recognizing the driver.

The normal driving behavior storing unit 416 stores normal driving behaviors for respective drivers. The driver recognition unit 417 recognizes the driver before the driver starts the driving of the vehicle. As shown in FIG. 12, the driver recognition unit 417 is connected with a driver face camera (FACE CAMERA) 405 that takes images of the driver's face. The driver recognition unit 417 recognizes the driver of the vehicle based on the images taken by the driver face camera 405. The driver recognition unit 417 may also be connected to another device that is able to recognize the driver, other than the driver face camera 405.

The driver recognition unit 417 outputs a recognition result of the driver to a condition detection unit 415. The condition detection unit 415 searches the normal driving behavior storing unit 416 for a normal driving behavior of the target driver recognized by the driver recognition unit 417. When the normal driving behavior of the driver recognized by the driver recognition unit 417 is stored in the normal driving behavior storing unit 416, the condition detection unit 415 refers the normal driving behavior corresponding to the recognized driver for detecting the condition of the driver. When the normal driving behavior of the driver recognized by the driver recognition unit 417 is not stored in the normal driving behavior storing unit 416, the condition detection unit 415 uses a default normal driving behavior for detecting the condition of the driver.

With this configuration, the difference of the driver is taken in the consideration when detecting the condition of the driver. Thus, the detected condition of the driver has a higher accuracy.

### Fifth Embodiment

The following will describe a driving assistance apparatus according to a fifth embodiment of the present disclosure. The following will mainly describe a part of the driving assistance apparatus according to the present embodiment, which is different from the third embodiment. The same reference symbols are used for the same or equivalent part with the third embodiment.

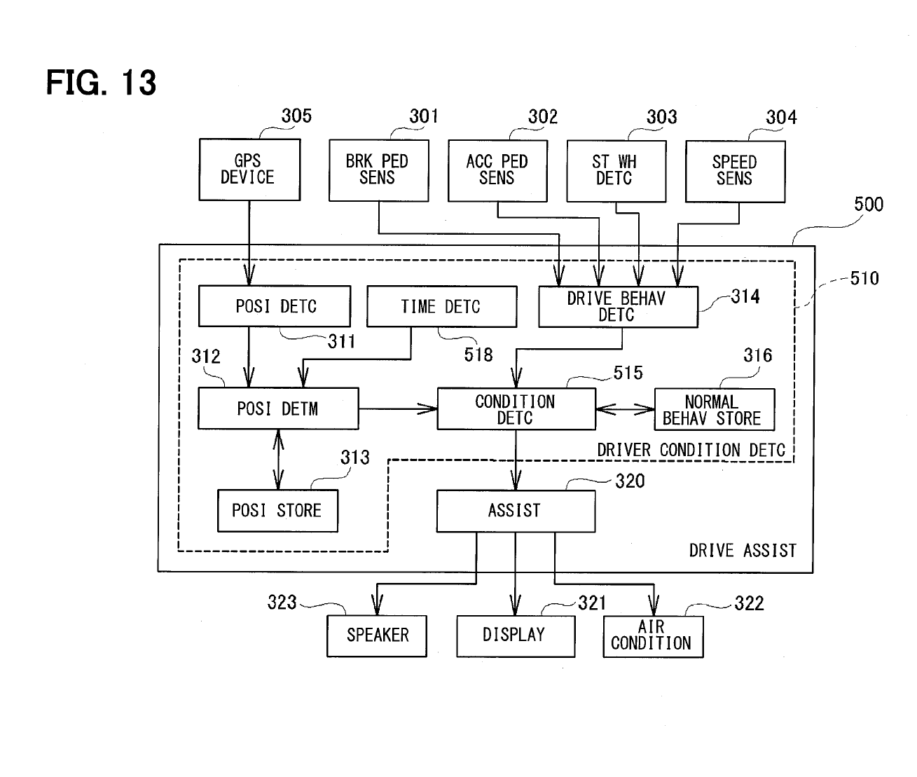

As shown in FIG. 13, the driving assistance apparatus 500 according to the present embodiment includes a driver condition detection apparatus 510. The driving assistance apparatus 500 according to the present embodiment is different from the driving assistance apparatus 300 according to the third embodiment at the following points. The driver condition detection apparatus 510 of the driving assistance apparatus 500 includes a present time detection unit (TIME DETC) 518.

In the foregoing embodiments, when the present position of the vehicle is equal to the detection target position, the driving behavior is detected for determining the condition of the driver. However, the same detection target position may have different traffic situations during different periods of time during a day. For example, when the driver passes through the detection target position at a time, which is different from a normal passing time of the detection target position, the traffic situation of the detection target position may be different from the traffic situation at the normal passing time. Thus, the driving assistance apparatus 500 may erroneously determine that the driver is in an abnormal condition.

In order to avoid above-described erroneous determination, the driving assistance apparatus 500 according to the present embodiment includes the present time detection unit 518. A condition detection unit 515 of the driving assistance apparatus 500 detects the driving behavior of the driver when the present position of the vehicle is equal to the detection target position and the present time transmitted from the present time detection unit 518 is included in a predetermined period of time. Herein, the predetermined period of time may be set with the normal passing time of the detection target position being included in the predetermined period of time.

With this configuration, the condition of the driver having a high accuracy can be detected without being affected by the traffic situation difference caused by the different periods of time.

### Other Embodiments

In the foregoing embodiments, the condition of the driver is detected based on the changes appeared in the start behavior or in the stop behavior at the detection target position. When the driver is not in a good condition, the driver may fail to notice the red traffic light and make a sudden brake or make a sudden operation of the steering wheel. When the driver is not in a good condition, the driver may fail to notice the turning of the traffic light from red or yellow to green and may make a sudden acceleration. Thus, the condition of the driver may also be detected based on these driving behaviors.

When the GPS device 305 fails to detect the present position of the vehicle, the driving behavior may be detected at all of the positions included in a travelling route. As another example, on the travelling route, the distance from the subject vehicle to the front vehicle may be detected, and the condition of the driver may be detected based on the driving behavior made during the travelling of the route or based on the distance from the subject vehicle to the front vehicle.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A driver condition detection apparatus detecting a condition of a driver during a driving of a vehicle, the driver condition detection apparatus comprising:
a position detection unit detecting a present position of the vehicle;
a position determination unit determining whether the present position of the vehicle is equal to a detection target position that is preliminarily set;
a driving behavior detection unit detecting a driving behavior of the driver or a driving behavior of the vehicle when the present position of the vehicle is equal to the detection target position; and
a condition detection unit detecting a condition of the driver based on the driving behavior.

2. The driver condition detection apparatus according to claim 1, further comprising
a driving behavior storing unit storing a driving behavior normally performed at the detection target position as a normal driving behavior,
wherein the condition detection unit detects the condition of the driver by comparing the driving behavior detected by the driving behavior detection unit with the normal driving behavior stored in the driving behavior storing unit.

3. The driver condition detection apparatus according to claim 1, wherein
the driving behavior detection unit detects a driving operation made by the driver as the driving behavior of the driver.

4. The driver condition detection apparatus according to claim 3, wherein
the driving behavior detection unit detects an operation made by the driver on an accelerator pedal of the vehicle as the driving behavior of the driver.

5. The driver condition detection apparatus according to claim 3, wherein
the driving behavior detection unit detects an operation made by the driver on a brake pedal of the vehicle as the driving behavior.

6. The driver condition detection apparatus according to claim 3, wherein
the driving behavior detection unit detects an operation made by the driver on a steering wheel of the vehicle as the driving behavior of the driver.

7. The driver condition detection apparatus according to claim 1, wherein
the driving behavior detection unit detects a behavior of the vehicle in response to a driving operation made by the driver as the driving behavior of the vehicle.

8. The driver condition detection apparatus according to claim 1, wherein
the driving behavior detection unit detects a start behavior performed at the detection target position for starting the vehicle from a stop state as the driving behavior.

9. The driver condition detection apparatus according to claim 1, wherein
the driving behavior detection unit detects a stop behavior performed at the detection target position for stopping the vehicle from a travelling state as the driving behavior.

10. A driving assistance apparatus detecting a condition of a driver during a driving of a vehicle, the driving assistance apparatus comprising:
a position detection unit detecting a present position of the vehicle;
a position determination unit determining whether the present position of the vehicle is equal to a detection target position that is preliminarily set;
a driving behavior detection unit detecting a driving behavior of the driver or a driving behavior of the vehicle when the present position of the vehicle is equal to the detection target position;
a condition detection unit detecting a condition of the driver based on the driving behavior that is detected by the driving behavior detection unit; and
a driving assistance unit performing a driving assistance based on the condition of the driver, which is detected by the condition detection unit.

11. A driver condition detection method for detecting a condition of a driver during a driving of a vehicle, the driver condition detection method comprising:
detecting a present position of the vehicle;
determining whether the present position of the vehicle is equal to a detection target position that is preliminarily set;
detecting a driving behavior of the driver or a driving behavior of the vehicle when the present position of the vehicle is equal to the detection target position; and
detecting a condition of the driver based on the driving behavior that is detected.

12. A driving assistance apparatus that performs a driving assistance operation, the driving assistance operation being at least one of an operation that assists a driving of the vehicle by a driver or an operation that notifies information necessary for the driving of the vehicle, the driving assistance apparatus comprising:
a parameter storing unit storing a plurality of operation parameters to be used for the driving assistance operation;
a biological information detection unit detecting a biological information of the driver;
a driving behavior detection unit detecting a driving behavior of the driver;
a condition determination unit determining a condition of the driver based on at least one of the biological information of the driver or the driving behavior of the driver;
a parameter selection unit selecting the operation parameters based on the condition of the driver determined by the condition determination unit and acquiring the operation parameters that are selected from the parameter storing unit; and
a driving assistance unit performing the driving assistance operation based on the operation parameters selected by the parameter selection unit.

13. The driving assistance apparatus according to claim 12, wherein
the parameter storing unit groups the plurality of operation parameters in a plurality of operation parameter sets corresponding to different conditions of the driver, and
the parameter selection unit selects and acquires one of the operation parameter sets from the parameter storing unit corresponding to the condition of the driver determined by the condition determination unit.

14. The driving assistance apparatus according to claim 12, wherein
the parameter selection unit further adjusts the operation parameters that are selected and acquired from the parameter storing unit corresponding to the condition of the driver determined by the condition determination unit, and
the driving assistance unit performs the driving assistance operation based on the operation parameters that are adjusted by the parameter selection unit.

15. A driving assistance method for performing a driving assistance operation, the driving assistance operation being at least one of an operation that assists a driving of the vehicle by a driver or an operation that notifies information necessary for the driving of the vehicle, the driving assistance method comprising:
detecting at least one of a biological information of the driver or a driving behavior of the driver;
determining a condition of the driver based on the at least one of the biological information of the driver or the driving behavior of the driver;
selecting operation parameters to be used in the driving assistance operation based on the condition of the driver; and
performing the driving assistance operation based on the operation parameters that are selected.
